(19) United States
(12) Patent Application Publication
(10) Pub. No.: US 2013/0338857 A1
(43) Pub. Date: Dec. 19, 2013

(54) Aircraft Passenger Health Management

(71) Applicant: Radhakrishna G. Sampigethaya, Snoqualmie, WA (US)

(72) Inventor: Radhakrishna G. Sampigethaya, Snoqualmie, WA (US)

(73) Assignee: THE BOEING COMPANY, Chicago, IL (US)

(21) Appl. No.: 13/524,657

(22) Filed: Jun. 15, 2012

(51) Int. Cl. G06F 17/00

(52) U.S. Cl. 701/3

(57) ABSTRACT

A method and apparatus for managing health of a passenger on an aircraft. A physiological condition of the passenger seated in a seat in a cabin in the aircraft is monitored using a passenger condition sensor to provide passenger condition information. An environmental condition in the cabin is monitored using a cabin condition sensor to provide cabin condition information. The passenger condition information and the cabin condition information are processed to provide passenger health information. The passenger health information is displayed to the passenger.

### BACKGROUND INFORMATION

1. Field

The present disclosure relates generally to systems and methods for identifying and improving the health and comfort of passengers on aircraft and other vehicles.

2. Background

Aircraft manufacturers, airlines, and other operators of commercial and other aircraft may recognize the desirability of being able to cater to the comfort and well-being of air travelers. As a result, aircraft may be designed to include various systems and aircraft operators may provide various services that are intended to support the health and comfort of passengers on the aircraft.

For example, aircraft may include equipment for monitoring and controlling the environmental conditions in an aircraft cabin. In some aircraft, equipment may be provided that allows passengers to adjust environmental conditions at their own seats in the aircraft cabin to some degree. Airlines also may provide various services for supporting the health and comfort of passengers on an aircraft. For example, an airline may provide an in-flight food service. Many current commercial and other aircraft may include equipment that may allow the crew of an aircraft to provide an on-demand response to medical emergencies on the aircraft. The systems and services that currently are provided to support the health and comfort of passengers on an aircraft may be designed for a broad range of passengers.

Accordingly, it would be beneficial to have a method and apparatus that takes into account one or more of the issues discussed above as well as possibly other issues.

### SUMMARY

An illustrative embodiment of the present disclosure provides a method for managing health of a passenger on an aircraft. A physiological condition of the passenger seated in a seat in a cabin in the aircraft is monitored using a passenger condition sensor to provide passenger condition information. An environmental condition in the cabin is monitored using a cabin condition sensor to provide cabin condition information. The passenger condition information and the cabin condition information are processed to provide passenger health information. The passenger health information is displayed to the passenger.

Another illustrative embodiment of the present disclosure provides an apparatus comprising a passenger condition sensor, a cabin condition sensor, a controller, and a passenger interface. The passenger condition sensor is configured to monitor a physiological condition of a passenger seated in a seat in a cabin in an aircraft to provide passenger condition information. The cabin condition sensor is configured to monitor an environmental condition in the cabin to provide cabin condition information. The controller is configured to receive the passenger condition information and the cabin condition information and to process the passenger condition information and the cabin condition information to provide passenger health information. The passenger interface is configured to display the passenger health information to the passenger.

Another illustrative embodiment of the present disclosure provides another method for managing health of a passenger on an aircraft. A physiological condition of the passenger in a cabin in the aircraft is monitored using a passenger condition sensor to provide passenger condition information. An environmental condition in the cabin is monitored using a cabin condition sensor to provide cabin condition information. Passenger provided health information is received as input from the passenger. The passenger condition information, the cabin condition information, and the passenger provided health information are processed to provide passenger health information.

The features, functions, and benefits may be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof will best be understood by reference to the following detailed description of illustrative embodiments of the present disclosure when read in conjunction with the accompanying drawings, wherein:

FIG. 1 is an illustration of a block diagram of a passenger health management system in accordance with an illustrative embodiment;

FIG. 2 is an illustration of a block diagram of a passenger health management system controller in accordance with an illustrative embodiment;

FIG. 3 is an illustration of a block diagram of a passenger interface in accordance with an illustrative embodiment;

FIG. 4 is an illustration of a block diagram of passenger condition sensors in accordance with an illustrative embodiment;

FIG. 5 is an illustration of a block diagram of cabin condition sensors in accordance with an illustrative embodiment;

FIG. 6 is an illustration of a flowchart of a process for passenger health management in accordance with an illustrative embodiment; and

FIG. 7 is an illustration of a block diagram of a data processing system in accordance with an illustrative embodiment.

### DETAILED DESCRIPTION

The different illustrative embodiments recognize and take into account a number of different considerations. “A number”, as used herein with reference to items, means one or more items. For example, “a number of different considerations” means one or more different considerations.

The different illustrative embodiments recognize and take into account that an airline or other operator of aircraft may both improve customer satisfaction and realize desirable cost savings by being more responsive to the health and comfort concerns of aircraft passengers. However, the information that aircraft operators may need to improve the comfort and well-being of passengers in an aircraft cabin may not currently be available.

The different illustrative embodiments recognize and take into account that an increasing number of smart applications available on the Internet and mobile devices enable individuals to keep track of information related to their health and well-being. However, no such capability exists for passengers during air travel.

The impact of aircraft passenger health issues on commercial airline operations may become more significant as the number of aircraft travelers and the number of flights taken by those travelers increases. Anticipated increases in the ages of aircraft passengers may further affect commercial airline operations because the health and comfort of older passengers may be more likely to be affected by aircraft cabin conditions.

The different illustrative embodiments recognize and take into account that desired improvements in aircraft passenger well-being may be achieved by the introduction of new features in aircraft cabin design, flight crew operations, or both. Making these improvements may benefit airlines by both increasing customer satisfaction and reducing airline operating costs. Thus, the illustrative embodiments provide systems and methods for obtaining and using aircraft passenger health information and aircraft cabin condition information to make such desired improvements in aircraft passenger well-being.

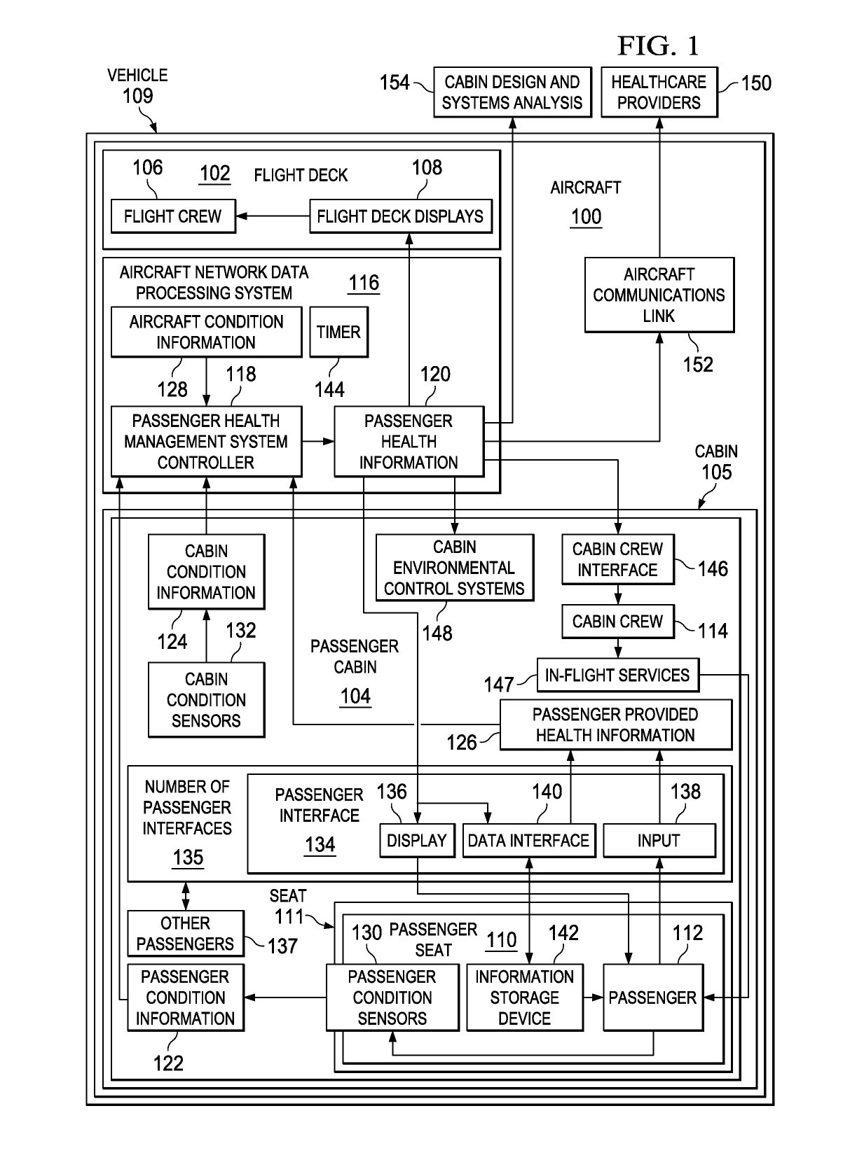

Turning first to FIG. 1, an illustration of a block diagram of a passenger health management system is depicted in accordance with an illustrative embodiment. In this illustrative example, a passenger health management system may be a system for managing the health of a passenger on aircraft 100. Aircraft 100 may be any type of aircraft that is configured for carrying passengers. Aircraft 100 may be operated by an airline, a military organization, or any other private or government entity.

Aircraft 100 may include flight deck 102 and passenger cabin 104. Passenger cabin 104 may or may not be separated from flight deck 102 by a wall, door, or other structure or combination of structures. Passenger cabin 104 may be on the same level of aircraft 100 as flight deck 102 or on a different level of aircraft 100 from flight deck 102. Flight deck 102 also may be referred to as a cockpit of aircraft 100.

For example, without limitation, flight deck 102 may include an area located near the front of aircraft 100. Flight deck 102 may include various controls that enable flight crew 106 to control the operation of aircraft 100. In another example, without limitation, flight crew 106 may include a pilot, a copilot, a navigator, other personnel, or various combinations of personnel for controlling the operation of aircraft 100 from flight deck 102.

Flight deck 102 may include flight deck displays 108. Flight deck displays 108 may be a number of displays in this illustrative example. Flight deck displays 108 may include any number of devices or systems for displaying various types of information for use by flight crew 106. The location of flight deck 102 on aircraft 100, the composition of flight crew 106, the number and types of devices and systems used to implement flight deck displays 108, and the types of information displayed to flight crew 106 may depend on various factors including, for example, without limitation, the type of aircraft 100, the operations to be performed by aircraft 100, specific flight or mission requirements, or other factors or various combinations of factors.

Aircraft 100 is an example of vehicle 109 in which passenger health management in accordance with an illustrative embodiment may be implemented. Vehicle 109 may be any vehicle that is configured for carrying passengers through the air, in space, on land, on the surface of water, under water, or in any other operating environment or combinations of environments. For example, without limitation, vehicle 109 may be a ferry or other vehicle configured for carrying passengers over water, a bus or other vehicle configured for carrying passengers over land, or another type of vehicle configured for carrying passengers in another operating environment or combinations of environments.

Passenger cabin 104 is the part of aircraft 100 in which a number of passengers may be seated during flight of aircraft 100. Passenger cabin 104 is one example of cabin 105 on aircraft 100. For example, without limitation, a crew rest area or other area may be another example of cabin 105 on aircraft 100 in which a number of passengers may be seated during a flight. In this example, the passengers also may be members of flight crew 106 of aircraft 100.

Passenger cabin 104 may include a number of passenger seats. For example, passenger cabin 104 may include passenger seat 110. Passenger seat 110 is one example of seat 111 on aircraft 100. For example, without limitation, seat 111 may be a seat for a member flight crew 106 of aircraft 100 or for another passenger on aircraft 100. Passenger 112 may be seated in passenger seat 110 during operation of aircraft 100.

Cabin crew 114 may work in passenger cabin 104 during operation of aircraft 100. For example, cabin crew 114 may include any number of individuals that are trained to provide for the safety and comfort of passenger 112 during the operation of aircraft 100. Cabin crew 114 may include the same or different individuals as flight crew 106.

Aircraft 100 also may include aircraft network data processing system 116. Aircraft network data processing system 116 may include a number of data processing systems and other devices for performing various functions on aircraft 100. Aircraft network data processing system 116 may be part of a network that provides for the exchange of data between data processing systems and other devices that may be located throughout aircraft 100.

Passenger health management system controller 118 may be implemented on aircraft network data processing system 116. Alternatively, passenger health management system controller 118 may be implemented, in whole or in part, on a data processing system that is separate from, but in communication with, aircraft network data processing system 116. For example, the data processing system may be implemented at passenger seat 110. In any case, in accordance with an illustrative embodiment, passenger health management system controller 118 is configured to receive information related to the health of passenger 112 from various sources on aircraft 100 and to process that information to provide passenger health information 120.

Passenger health information 120 may be distributed and used in various ways to improve the health and well-being of passenger 112. In accordance with an illustrative embodiment, passenger health management system controller 118 may be configured to receive passenger condition information 122, cabin condition information 124, passenger provided health information 126, aircraft condition information 128, or other types of information that may be related to the health of passenger 112, or various combinations of such information. Passenger condition information 122 may be provided to passenger health management system controller 118 by various passenger condition sensors 130. For example, passenger condition sensors 130 may include various sensors for sensing various physiological conditions of passenger 112. Passenger condition sensors 130 may be located in passenger seat 110, not in passenger seat 110 but near passenger 112 in passenger cabin 104, or both.

Cabin condition information 124 may be provided to passenger health management system controller 118 from cabin condition sensors 132. Cabin condition sensors 132 may include a number of sensors for identifying various environmental conditions in passenger cabin 104 that may affect the health of passenger 112. Cabin condition sensors 132 may include sensors for identifying general cabin conditions of passenger cabin 104 as a whole, or conditions at specific portions of passenger cabin 104. For example, without limitation, cabin condition sensors 132 may be positioned and configured to identify cabin conditions at or near passenger seat 110.

Passenger condition sensors 130 and cabin condition sensors 132 may together form a monitoring system for a passenger health management system in accordance with an illustrative embodiment. The modalities of passenger condition sensors 130 and cabin condition sensors 132 may be selected based on the individual characteristics of passenger 112 and of passenger cabin 104 that are desired to be monitored.

The granularity of passenger condition information 122 and cabin condition information 124 that is provided by passenger condition sensors 130 and cabin condition sensors 132, respectively, may be selected based on the ways in which passenger health information 120 provided by the passenger health management system is to be used. For example, without limitation, the granularity of passenger condition information 122 and cabin condition information 124 that is provided by passenger condition sensors 130 and cabin condition sensors 132 may be selected based on the desired services to be provided to passenger 112 in passenger cabin 104.

In one example, sensors placed in a single seat in passenger cabin 104 may be used to provide monitoring for that seat, the environment around that seat, or both. Sensors placed in all of the passenger seats in passenger cabin 104 may be used to provide health related information for individual passengers. In this case, services provided to passengers in passenger cabin 104 may be tailored for each individual passenger. As another example, sensors may be placed in passenger cabin 104 to monitor health related information for a group of passengers. Aggregated health information for a group of passengers in passenger cabin 104 may be used to provide services tailored to the average passenger within the monitored group of passengers.

As a further example, sensors may be placed to monitor health related information for passengers in a number of seats in passenger cabin 104 that are assigned to specific groups of passengers. These seats may be located in specially designated areas in passenger cabin 104. For example, without limitation, passengers wishing to check their health conditions may use these specially designated seats for an assigned maximum period of time during a flight.

Passenger provided health information 126 may include information related to the health of passenger 112 that is provided to passenger health management system controller 118 by passenger 112. For example, passenger provided health information 126 may include information identifying specific health conditions or concerns of passenger 112. For example, without limitation, passenger provided health information 126 may be used to indicate if passenger 112 has any past or current illness or other health condition, allergies, dietary preferences, or other information related to the health and well-being of passenger 112 that may be provided by passenger 112.

Passenger 112 may provide passenger provided health information 126 to passenger health management system controller 118 using passenger interface 134. Passenger interface 134 may include display 136, input 138, and data interface 140. For example, without limitation, passenger interface 134 may be implemented, in whole or in part, as part of an in-flight entertainment system that is provided to passenger 112 on aircraft 100. Passenger interface 134 may be provided on the back of the seat in front of passenger seat 110, attached to passenger seat 110, or in any other appropriate location or number of locations for use by passenger 112 when passenger 112 is seated in passenger seat 110. Passenger interface 134 is one of number of passenger interfaces 135 that may be provided on aircraft 100. For example, number of passenger interfaces 135 may be provided for passenger 112 and for other passengers 137 on aircraft 100.

Display 136 may include any device for displaying information to passenger 112. For example, display 136 may be used to present a graphical user interface to passenger 112 that prompts passenger 112 to enter passenger provided health information 126. Input 138 may include any device that is configured to allow passenger 112 to enter information manually into passenger interface 134. For example, without limitation, input 138 may be provided by a touch screen display. Passenger 112 may provide passenger provided health information 126 by entering such information manually via input 138.

Data interface 140 may be configured to provide for the exchange of data between passenger interface 134 and information storage device 142. For example, information storage device 142 may be any portable device for storing information that is brought on board aircraft 100 by passenger 112. For example, without limitation, information storage device 142 may be a portable memory device, a portable communication device, such as a cellular telephone, a portable data processing device, such as a laptop or tablet computer, or another information storage device 142 that may be brought on board aircraft 100 by passenger 112. Data interface 140 may be configured to provide for the wireless exchange of information between passenger interface 134 and information storage device 142, to provide for the exchange of information between information storage device 142 and data interface 140 via a hardware connection, or both.

Passenger provided health information 126 may be stored on information storage device 142. In this case, passenger 112 may provide passenger provided health information 126 to passenger health management system controller 118 by connecting information storage device 142 to data interface 140 and uploading passenger provided health information 126 from information storage device 142 to passenger health management system controller 118 via data interface 140 of passenger interface 134.

Aircraft condition information 128 may include any other information related to the operation of aircraft 100 that may affect the health or comfort of passenger 112. Aircraft condition information 128 may be provided to passenger health management system controller 118 via any appropriate source of such information. Aircraft condition information 128 may be provided from information sources on board aircraft 100, off board aircraft 100, or both. For example, without limitation, aircraft condition information 128 may include information identifying the phase of flight of aircraft 100, weather or other environmental conditions, the time of day of a flight, whether aircraft 100 is experiencing any emergency conditions, whether the flight of aircraft 100 is behind or ahead of schedule, or any other aircraft condition information 128 that may affect the health of passenger 112, or any combination of such information.

Passenger condition information 122, cabin condition information 124, passenger provided health information 126, and aircraft condition information 128 received by passenger health management system controller 118 may be processed to provide passenger health information 120. Passenger health information 120 may be derived by combining the information received by passenger health management system controller 118 in various ways and analyzing the combination of such data. For example, passenger health management system controller 118 may use timer 144 to time stamp the various types of information related to the health of passenger 112 as that information is received by passenger health management system controller 118. Passenger health management system controller 118 may then use the time stamped data to identify various relationships between the received information.

From this received information, passenger health management system controller 118 may automatically diagnose health conditions of passenger 112. The diagnosis of health conditions that is performed by passenger health management system controller 118 may include automatically identifying health conditions of interest for passenger 112.

The ways in which various types of health related information are combined by passenger health management system controller 118 may depend upon the ways in which passenger health information 120 is to be used. Passenger health management system controller 118 also may format passenger health information 120 as appropriate for the ways in which passenger health information 120 is to be used.

Passenger health information 120 may be distributed for various uses. For example, passenger health information 120 provided by passenger health management system controller 118 may include health information that is specifically related to passenger 112. Passenger health information 120 may be provided to passenger interface 134 and presented to passenger 112 on display 136. Personalized passenger health information 120 of this type also may be made available for passenger 112 to download into information storage device 142 via data interface 140.

Passenger health information 120 also may be displayed to other passengers 137 via number of passenger interfaces 135. For example, without limitation, other passengers 137 may include a number of companions that are traveling with passenger 112. Passenger 112 may indicate, via input 138, that passenger 112 approves the providing of passenger health information 120 for passenger 112 to other passengers 137.

Passenger health information 120 also may be provided to cabin crew interface 146. For example, cabin crew interface 146 may include a display device, audio system, or both. Passenger health information 120 may include an indication of a health condition of interest for passenger 112 on cabin crew interface 146. Cabin crew 114 may then respond as appropriate. For example, based on passenger health information 120 provided on cabin crew interface 146, cabin crew 114 may provide in-flight services 147 to passenger 112 that satisfy the particular health and comfort needs of passenger 112.

In a similar way, passenger health information 120 may be provided for display on flight deck displays 108. Flight crew 106 may then take appropriate action in response to any indicated passenger health condition of interest or other information provided as part of passenger health information 120 presented on flight deck displays 108.

In accordance with an illustrative embodiment, passenger health information 120 may be provided to and used by cabin environmental control systems 148. Cabin environmental control systems 148 may be configured to automatically control various environmental conditions in passenger cabin 104 in response to passenger health information 120.

Passenger health information 120 also may be provided to users off board aircraft 100. Such users may be authorized by passenger 112 to receive passenger health information 120. For example, during a flight, passenger health information 120 may be provided to healthcare providers 150 on the ground. Passenger health information 120 may be provided to healthcare providers 150, or other authorized users of such information, via aircraft communications link 152. For example, without limitation, aircraft communications link 152 may include a terrestrial radio link, satellite radio link, or an airborne network link to the ground system and the Internet. For example, if passenger 112 experiences a health condition of interest during a flight, passenger health information 120 for passenger 112 may be provided to healthcare providers 150 to improve the ability of healthcare providers 150 to help cabin crew 114 and flight crew 106 respond appropriately to such a condition.

Passenger health information 120 also may be used for cabin design and systems analysis 154. For example, passenger health information 120 from a number of flights may be analyzed to determine the relationship between current cabin designs and the operation of current cabin systems as well as the health and well-being of passengers on aircraft 100 during various operating conditions. This analysis may be used to develop improved cabin designs and systems that may be implemented to improve the well-being and comfort of future aircraft passengers.

The illustration of FIG. 1 is not meant to imply physical or architectural limitations to the manner in which different illustrative embodiments may be implemented. Other components in addition to, in place of, or both in addition to and in place of the ones illustrated may be used. Some components may be unnecessary in some illustrative embodiments. Also, the blocks are presented to illustrate some functional components. One or more of these blocks may be combined or divided into different blocks when implemented in different illustrative embodiments.

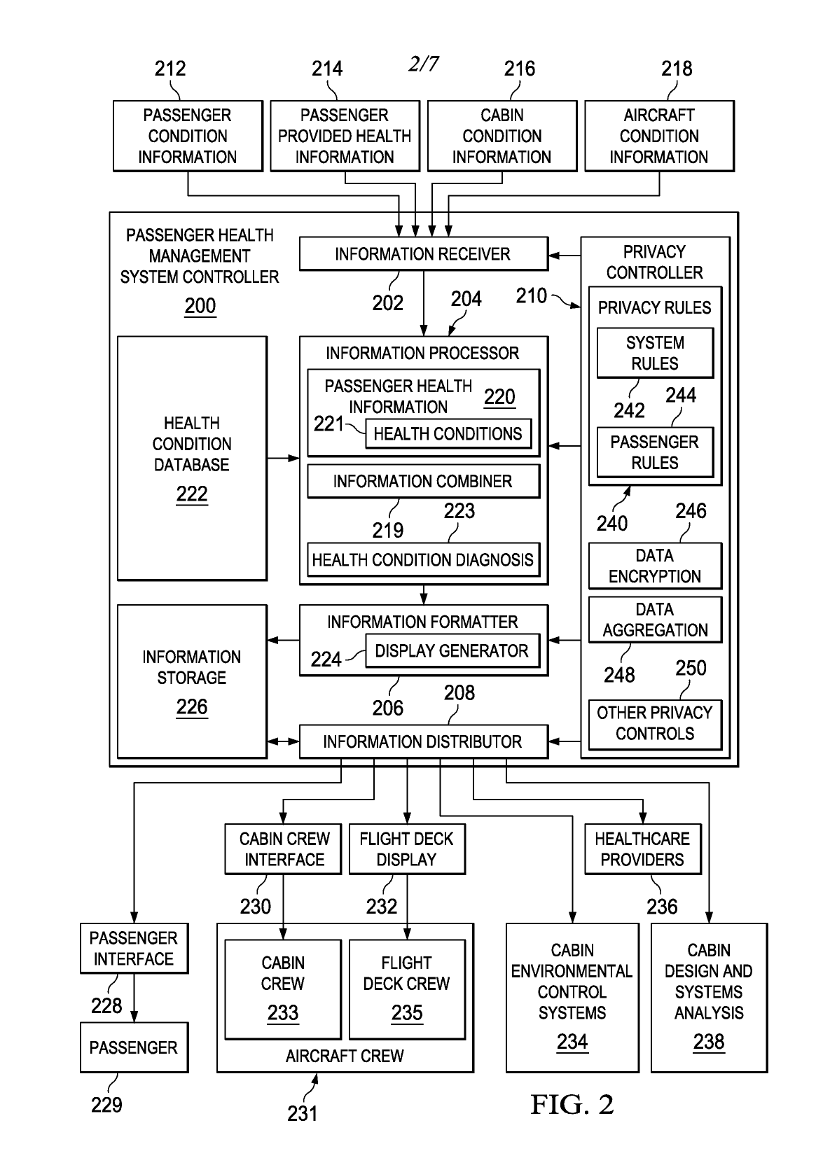

Turning now to FIG. 2, an illustration of a block diagram of a passenger health management system controller is depicted in accordance with an illustrative embodiment. In this example, passenger health management system controller 200 is an example of one implementation of passenger health management system controller 118 in FIG. 1. Passenger health management system controller 200 may include information receiver 202, information processor 204, information formatter 206, information distributor 208, and privacy controller 210.

Information receiver 202 is configured to receive various types of information that may be related to the health of a passenger on an aircraft or other vehicle. For example, without limitation, information receiver 202 may be configured to receive passenger condition information 212, passenger provided health information 214, cabin condition information 216, aircraft condition information 218, or other information related to the health of a passenger. As discussed above, passenger condition information 212 may include information related to the physiological condition of a passenger that is provided by various passenger condition sensors. Passenger provided health information 214 may include health related information that is provided by the passenger. Cabin condition information 216 may include information related to environmental conditions in a passenger cabin that may be provided by various cabin condition sensors.

Information received by information receiver 202 may be processed by information processor 204 to provide passenger health information 220. The way in which the information is processed by information processor 204 may be defined by various rules and may be based on the way in which passenger health information 220 is to be used.

For example, information processor 204 may include information combiner 219. Information combiner 219 may be configured to combine passenger condition information 212 with other information received by information receiver 202 to provide passenger health information 220 that presents an integrated view of passenger health in relation to the passenger environment. For example, without limitation, information combiner 219 may be configured to combine passenger condition information 212 with cabin condition information 216 to provide passenger health information 220 that presents a view of the health of a passenger in relation to the environmental conditions in the passenger cabin.

Passenger health information 220 may include indications of health conditions 221. For example, information processor 204 may be configured to perform health condition diagnosis 223. Information processor 204 may be configured to perform health condition diagnosis 223 by comparing the health information for a particular passenger to definitions of possible health conditions as provided in health condition database 222. An indication of health conditions 221 may be included in passenger health information 220 in response to a determination by health condition diagnosis 223 that a passenger is experiencing, or is likely to experience, a particular health condition of interest.

Passenger health information 220 derived by information processor 204 from the received health information may be formatted by information formatter 206. Information formatter 206 may be configured to format passenger health information 220 in an appropriate manner for the way in which passenger health information 220 is to be used. For example, without limitation, information formatter 206 may include display generator 224. Display generator 224 may be configured to generate an appropriate display of passenger health information 220 for presentation to a passenger, aircraft crew member, or other appropriate user of such information.

Passenger health information 220, as formatted by information formatter 206, may be distributed to various authorized users by information distributor 208. Passenger health information 220 may be distributed by information distributor 208 in real time, or near real time, as such information is generated by information processor 204 and formatted by information formatter 206. Alternatively, or additionally, passenger health information 220 may be stored in information storage 226 for distribution to authorized users by information distributor 208 at a later time. For example, without limitation, passenger health information 220 may be retrieved from information storage 226 and distributed by information distributor 208 in response to a request for such information, at a scheduled time, or both.

For example, without limitation, information distributor 208 may be configured to provide passenger health information 220 to passenger interface 228, cabin crew interface 230, flight deck display 232, cabin environmental control systems 234, healthcare providers 236, cabin design and systems analysis 238, other users of such information, or various combinations of users of such information.

Passenger health information 220 may be provided to passenger 229 via passenger interface 228. Passenger 229 may be the passenger whose health is described by passenger health information 220. As another example, passenger 229 may be another passenger to whom the passenger whose health is described by passenger health information 220 has given permission to receive passenger health information 220.

Passenger health information 220 may be provided to aircraft crew 231 via cabin crew interface 230 and flight deck display 232. Aircraft crew 231 may include cabin crew 233 and flight deck crew 235. Passenger health information 220 may be provided to cabin crew 233 via cabin crew interface 230. Passenger health information 220 may be provided to flight deck crew 235 via flight deck display 232.

The security of information received, processed, and distributed by passenger health management system controller 200 may be controlled by privacy controller 210. Privacy controller 210 may include functionality that is implemented at appropriate points in information receiver 202, information processor 204, information formatter 206, information distributor 208, or other appropriate points or combinations of points in passenger health management system controller 200.

Privacy controller 210 may be configured to control the privacy of the health related information received, processed, and distributed by passenger health management system controller 200 in accordance with privacy rules 240.

Privacy rules 240 may include system rules 242 and passenger rules 244. System rules 242 may include privacy rules 240 that are applied generally to information received, processed, and distributed by passenger health management system controller 200. System rules 242 may be controlled by the operator of an aircraft or other vehicle. For example, system rules 242 may include operator defined rules, as well as rules for protecting the privacy of health related information as provided by governmental regulation.

Passenger rules 244 may include privacy rules 240 that are defined for individual passengers. For example, individual passengers may grant or deny permission to use their personal health information in any particular way or to provide their personal health information to any particular user. Passenger rules 244 may indicate such passenger preferences for the use and distribution of their passenger health information.

Privacy controller 210 may implement various functions for protecting the privacy of the health information received, processed, and distributed by passenger health management system controller 200. For example, without limitation, such functions may include data encryption 246, data aggregation 248, other privacy controls 250, and various combinations of such controls. Data aggregation 248 may include combining health information for a number of passengers in a manner such that the association between health information and the identity of particular individual passengers cannot be determined from passenger health information 220, but in a manner such that the potential benefit of passenger health information 220 for various purposes is maintained.

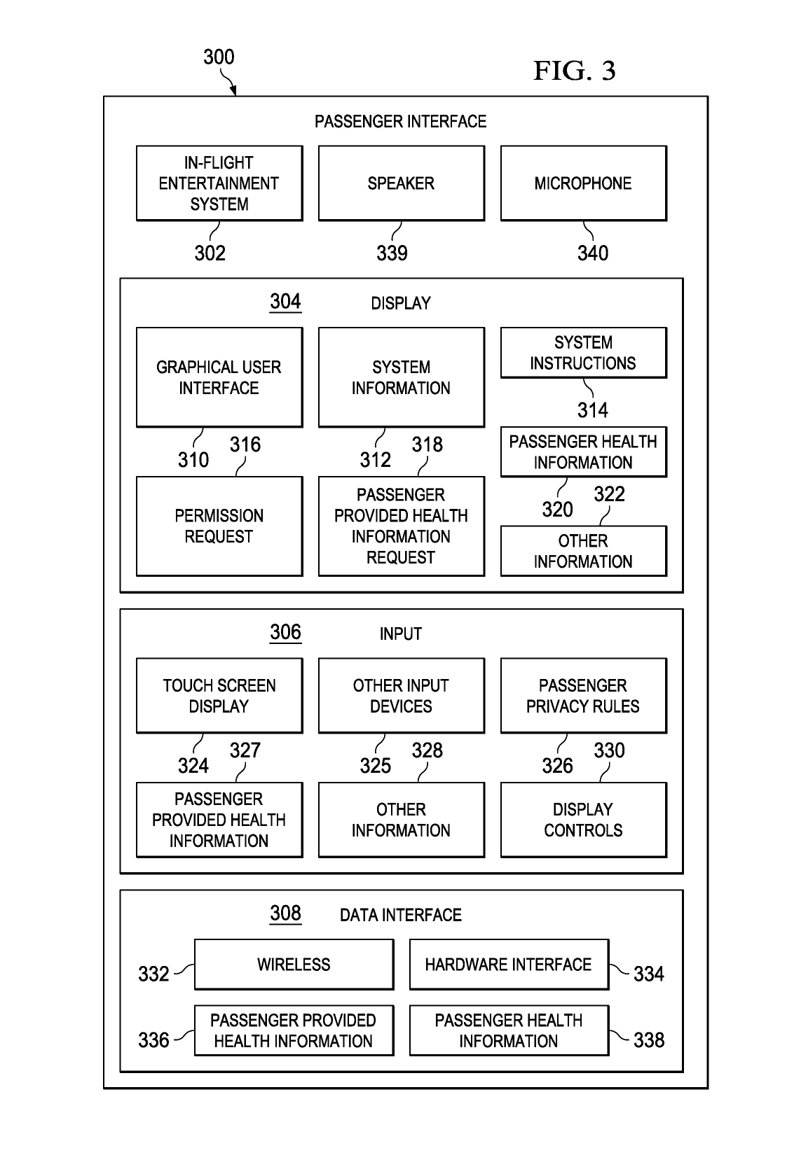

Turning now to FIG. 3, an illustration of a block diagram of a passenger interface is depicted in accordance with an illustrative embodiment. In this example, passenger interface 300 is an example of one implementation of passenger interface 134 in FIG. 1. For example, without limitation, passenger interface 300 may be implemented, in whole or in part, as part of in-flight entertainment system 302 for providing information and entertainment to a passenger on an aircraft. In accordance with an illustrative embodiment, passenger interface 300 includes display 304, input 306, and data interface 308.

Display 304 may include any device for displaying information to a passenger. For example, without limitation, display 304 may include a touch screen display or another type of display device, or various combinations of display devices. For example, without limitation, display 304 may be configured to display graphical user interface 310 to a passenger. Graphical user interface 310 may be configured to allow a passenger to interact with a passenger health management system in accordance with an illustrative embodiment.

Various types of information may be presented to a passenger on display 304. Such information may be presented to a passenger on display 304 as a part of graphical user interface 310, separate from graphical user interface 310, or both. For example, without limitation, information that may be presented to a passenger on display 304 may include system information 312, system instructions 314, permission request 316, passenger provided health information request 318, passenger health information 320, other information 322, or various different types of information in various combinations. System information 312 may include information that describes a passenger health management system in accordance with an illustrative embodiment. System instructions 314 may include information explaining how a passenger may interact with and use the passenger health management system. Permission request 316 may include a request for a passenger to grant or deny permission to access the personal health information of the passenger in the passenger health management system. The response of the passenger to permission request 316 may be used to establish privacy rules that may be applied by the passenger health management system to control the privacy of the health information of the passenger in the manner identified by the passenger. Passenger provided health information request 318 may include a request for the passenger to enter information related to the health of the passenger. Passenger health information 320 may include information concerning the health of the passenger and may be obtained and updated in real time or near real time by passenger health management system. For example, passenger health information 320 may include information obtained from passenger condition sensors and other sources of passenger related information.

Input 306 may include any device that allows a passenger to input information manually into the passenger health management system. For example, without limitation, input 306 may be implemented, along with display 304, as touch-screen display 324. Alternatively, or additionally, input 306 may include a keyboard, keypad, or other input devices 325 that are configured to allow the passenger to enter information into the passenger health management system manually.

For example, without limitation, information that may be provided from the passenger to the passenger health management system via input 306 may include passenger privacy rules 326, passenger provided health information 327, other information 328, or various combinations of such information. Passenger privacy rules 326 may be entered in response to permission request 316. Passenger provided health information 327 may be provided via input 306 in response to passenger provided health information request 318.

Input 306 also may be configured to receive display controls 330 from the passenger. Display controls 330 may include interactions by the passenger with input 306 to control what information is presented on display 304, how information is presented on display 304, or both.

Data interface 308 may be configured to provide an interface between a passenger information storage device and the passenger health management system. For example, data interface 308 may include wireless 332, hardware interface 334, or both. Data interface 308 may be configured to allow a passenger to upload information from their information storage device to the passenger health management system via the data interface 308. For example, without limitation, data interface 308 may be configured to allow a passenger to upload passenger provided health information 336 into the passenger health management system from the information storage device of the passenger via data interface 308. Data interface 308 also may be configured to allow a passenger to download information from the passenger health management system to the information storage device of the passenger via data interface 308. For example, without limitation, data interface 308 may be configured to allow a passenger to download passenger health information 338 or other information from the passenger health management system to the information storage device of the passenger via data interface 308.

Passenger interface 300 may include speaker 339 and microphone 340. In accordance with an illustrative embodiment, information that may be displayed on display 304 may be presented to a passenger in audible form via speaker 339. A passenger may provide information to a passenger health management system, such as the information provided via input 306 as described above, by speaking into microphone 340. Appropriate speech recognition technology may be used to convert such information provided by speaking into microphone 340 into an appropriate data format for processing by the passenger health management system.

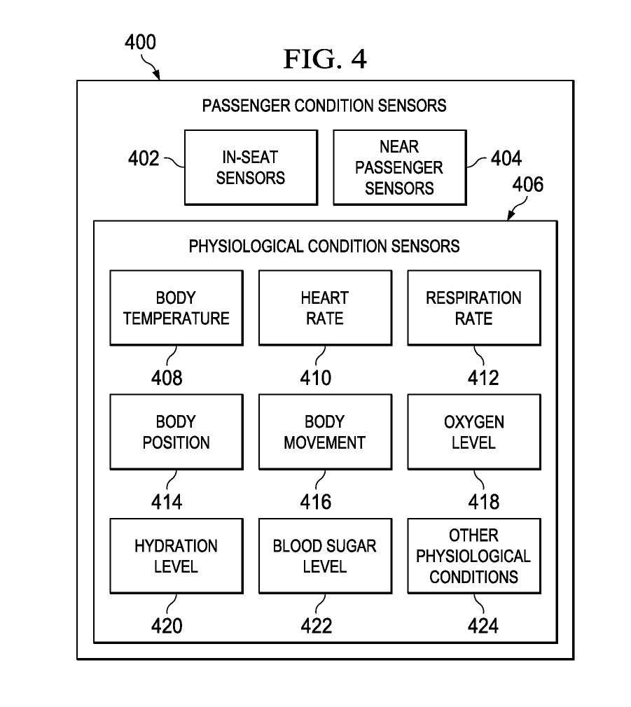

Turning now to FIG. 4, an illustration of a block diagram of passenger condition sensors is depicted in accordance with an illustrative embodiment. In this example, passenger condition sensors 400 are examples of passenger condition sensors 130 in FIG. 1.

Passenger condition sensors 400 may include in-seat sensors 402, near passenger sensors 404, or both. In-seat sensors 402 may be located in or on the seat of the passenger. Near passenger sensors 404 may not be positioned in or on the passenger seat, but may be positioned near the passenger to obtain desired passenger condition information.

Passenger condition sensors 400 may include various physiological condition sensors 406. Physiological condition sensors 406 may be configured to identify various physiological conditions of a passenger. For example, without limitation, physiological conditions that may be identified by physiological condition sensors 406 may include body temperature 408, heart rate 410, respiration rate 412, body position 414, body movement 416, oxygen level 418, hydration level 420, blood sugar level 422, other physiological conditions 424, or various combinations of physiological conditions.

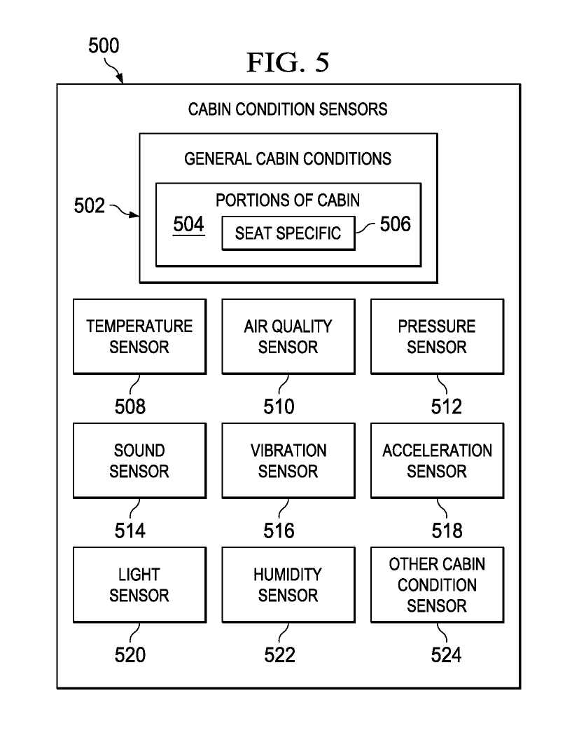

Turning now to FIG. 5, an illustration of a block diagram of cabin condition sensors is depicted in accordance with an illustrative embodiment. In this example, cabin condition sensors 500 is an example of cabin condition sensors 132 in FIG. 1.

Cabin condition sensors 500 identify environmental conditions in a passenger cabin that may affect passenger health. For example, cabin condition sensors 500 may identify general cabin conditions 502 throughout a passenger cabin. Alternatively, or additionally, cabin condition sensors 500 may include sensors for identifying such environmental conditions in portions of cabin 504. In one example, cabin condition sensors 500 may identify the environmental conditions in the passenger cabin for seat specific 506 portions of cabin 504.

Cabin condition sensors 500 may include a variety of sensor devices for identifying various environmental conditions in the passenger cabin that may be relevant to passenger health. For example, without limitation, cabin condition sensors 500 may include temperature sensor 508, air quality sensor 510, pressure sensor 512, sound sensor 514, vibration sensor 516, acceleration sensor 518, light sensor 520, humidity sensor 522, other cabin condition sensor 524, or various combinations of sensors for identifying various combinations of environmental conditions in the passenger cabin.

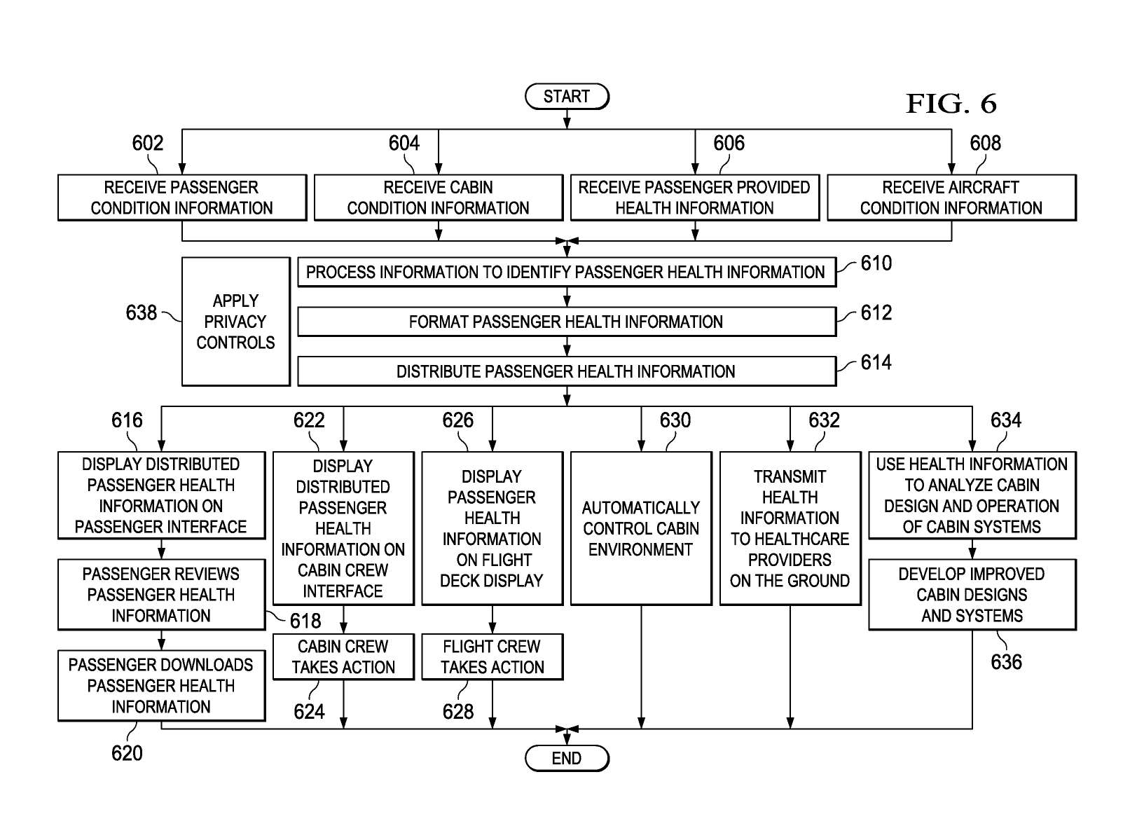

Turning now to FIG. 6, an illustration of a flowchart of a process for passenger health management is depicted in accordance with an illustrative embodiment. The process may begin by receiving passenger condition information (operation 602), receiving cabin condition information (operation 604), receiving passenger provided health information (operation 606), and receiving aircraft condition information (operation 608). The various types of information received in operations 602, 604, 606, and 608 may be processed to identify passenger health information (operation 610). The passenger health information then may be formatted (operation 612) as appropriate for the manner in which the passenger health information will be used. The passenger health information then may be distributed for use (operation 614). In this example, operations 602, 604, 606, 608, 610, 612, and 614 may be performed by passenger health management system controller 118 in FIG. 1.

Distributed passenger health information may be displayed on a passenger interface (operation 616). The passenger may review the passenger health information as displayed (operation 618). The passenger also may download the displayed passenger health information onto an information storage device (operation 620), with the process terminating thereafter.

Distributed passenger health information also may be displayed on a cabin crew interface (operation 622). The cabin crew may take appropriate action in response to the passenger health information presented on the cabin crew interface (operation 624) with the process terminating thereafter. For example, without limitation, action taken by the cabin crew in operation 624 may include appropriate actions for improving the well-being or comfort of the passenger.

Passenger health information also may be displayed on a flight deck display (operation 626). The flight crew may take appropriate action in response to the displayed information (operation 628), with the process terminating thereafter.

The distributed passenger health information also may be used to automatically control the cabin environment (operation 630) with the process terminating thereafter.

The distributed passenger health information also may be transmitted to healthcare providers on the ground (operation 632) with the process terminating thereafter.

Distributed passenger health information also may be used to analyze cabin design and the operation of cabin systems (operation 634). This analysis may be used to develop improved cabin designs and systems (operation 636), with the process terminating thereafter.

Privacy controls may be applied (operation 638) during any operation in the process. The privacy controls applied in operation 638 may include various controls for protecting personal health information as such information is processed and used throughout the process. The privacy controls applied in operation 638 may, for example, implement various privacy rules that define how personal health information may be handled and used.

One or more of the illustrative embodiments provide a capability to monitor the physiological characteristics of individual passengers in an aircraft cabin. Personal passenger health information may be derived from the monitored physiological characteristics and used to generate personalized passenger health reports. Such personalized passenger health reports may be generated securely and delivered in a secure manner to the passenger and other authorized persons.

In accordance with an illustrative embodiment, the cabin environment experienced by a passenger at the seat of the passenger during a flight is captured. The passenger is able to view real time health information on an in-flight entertainment screen and obtain nutrition and other suggestions to improve the well-being of the passenger during a flight. The passenger may be able to retrieve health data collected during a flight onto a personal storage device or computer through an interface on or near the seat of the passenger. One or more of the illustrative embodiments may enable a passenger to communicate health information to a healthcare provider and interact with the provider to obtain an assessment and advice during a flight.

One or more of the illustrative embodiments may enable a cabin crew to better serve passengers on an aircraft, to improve aircraft passenger well-being, and to improve airline cost savings and performance. For example, one or more of the illustrative embodiments may be used to obtain personal passenger health information that may be used to support timely and accurate decision making by aircraft crew members. One or more of the illustrative embodiments provide a capability for an aircraft flight crew to cater to the specific needs of individual passengers in an aircraft cabin. For example, personal passenger health information obtained in accordance with an illustrative embodiment may enable an airborne flight crew to provide passenger-specific health and nutrition services.

One of more of the illustrative embodiments may enable a comparison between a passenger health profile and a cabin environment profile generated from passenger condition sensors and cabin sensors, respectively, located in or near a seat. Such a comparison may yield insights into the interactions between the cabin environment and individual characteristics of passengers.

One or more of the illustrative embodiments may provide new techniques to protect the privacy of passenger health data collected and shared by aircraft systems and off-board systems.

Personal passenger health information obtained in accordance with an illustrative embodiment also may be used for research on the impact of the aircraft cabin environment on passenger health. This research may lead to changes in aircraft cabin design, operation, or both to improve the impact of the cabin environment on passenger health.

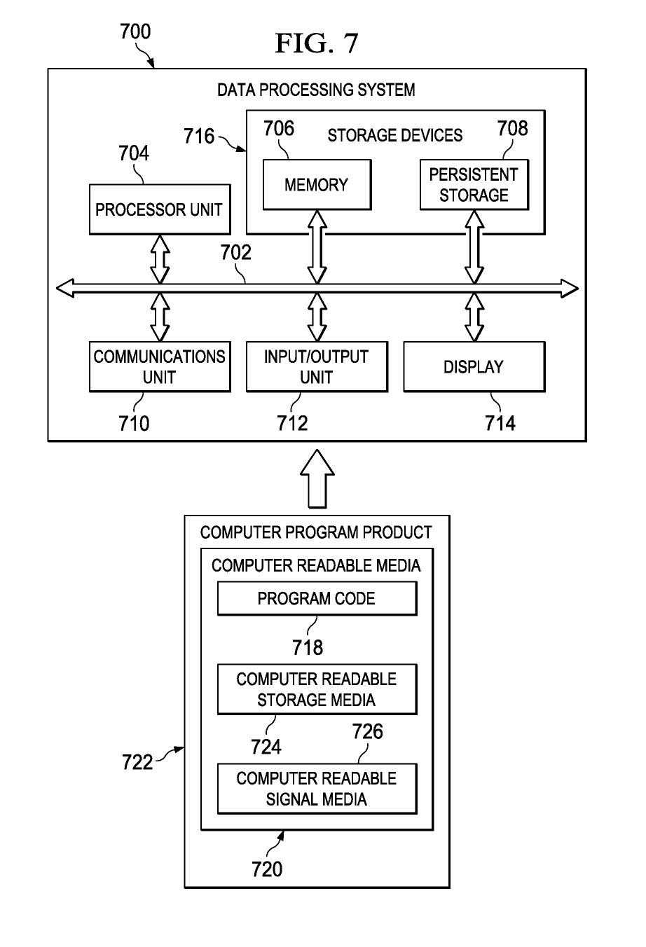

Turning now to FIG. 7, an illustration of a block diagram of a data processing system is depicted in accordance with an illustrative embodiment. In this example, data processing system 700 is an example of one implementation of a data processing system for implementing passenger health management system controller 118 in FIG. 1.

In this illustrative example, data processing system 700 includes communications fabric 702. Communications fabric 702 provides communications between processor unit 704, memory 706, persistent storage 708, communications unit 710, input/output (I/O) unit 712, and display 714. Memory 706, persistent storage 708, communications unit 710, input/output (I/O) unit 712, and display 714 are examples of resources accessible by processor unit 704 via communications fabric 702.

Processor unit 704 serves to run instructions for software that may be loaded into memory 706. Processor unit 704 may be a number of processors, a multi-processor core, or some other type of processor, depending on the particular implementation. Further, processor unit 704 may be implemented using a number of heterogeneous processor systems in which a main processor is present with secondary processors on a single chip. As another illustrative example, processor unit 704 may be a symmetric multi-processor system containing multiple processors of the same type.

Memory 706 and persistent storage 708 are examples of storage devices 716. A storage device is any piece of hardware that is capable of storing information, such as, for example, without limitation, data, program code in functional form, and other suitable information either on a temporary basis or a permanent basis. Storage devices 716 also may be referred to as computer readable storage devices in these examples. Memory 706, in these examples, may be, for example, a random access memory or any other suitable volatile or non-volatile storage device. Persistent storage 708 may take various forms, depending on the particular implementation.

For example, persistent storage 708 may contain one or more components or devices. For example, persistent storage 708 may be a hard drive, a flash memory, a rewritable optical disk, a rewritable magnetic tape, or some combination of the above. The media used by persistent storage 708 also may be removable. For example, a removable hard drive may be used for persistent storage 708.

Communications unit 710, in these examples, provides for communications with other data processing systems or devices. In these examples, communications unit 710 is a network interface card. Communications unit 710 may provide communications through the use of either or both physical and wireless communications links.

Input/output unit 712 allows for input and output of data with other devices that may be connected to data processing system 700. For example, input/output unit 712 may provide a connection for user input through a keyboard, a mouse, and/or some other suitable input device. Further, input/output unit 712 may send output to a printer. Display 714 provides a mechanism to display information to a user.

Instructions for the operating system, applications, and/or programs may be located in storage devices 716, which are in communication with processor unit 704 through communications fabric 702. In these illustrative examples, the instructions are in a functional form on persistent storage 708. These instructions may be loaded into memory 706 for execution by processor unit 704. The processes of the different embodiments may be performed by processor unit 704 using computer-implemented instructions, which may be located in a memory, such as memory 706.

These instructions are referred to as program instructions, program code, computer usable program code, or computer readable program code that may be read and executed by a processor in processor unit 704. The program code in the different embodiments may be embodied on different physical or computer readable storage media, such as memory 706 or persistent storage 708.

Program code 718 is located in a functional form on computer readable media 720 that is selectively removable and may be loaded onto or transferred to data processing system 700 for execution by processor unit 704. Program code 718 and computer readable media 720 form computer program product 722 in these examples. In one example, computer readable media 720 may be computer readable storage media 724 or computer readable signal media 726.

Computer readable storage media 724 may include, for example, an optical or magnetic disk that is inserted or placed into a drive or other device that is part of persistent storage 708 for transfer onto a storage device, such as a hard drive, that is part of persistent storage 708. Computer readable storage media 724 also may take the form of a persistent storage, such as a hard drive, a thumb drive, or a flash memory, that is connected to data processing system 700. In some instances, computer readable storage media 724 may not be removable from data processing system 700.

In these examples, computer readable storage media 724 is a physical or tangible storage device used to store program code 718 rather than a medium that propagates or transmits program code 718. Computer readable storage media 724 is also referred to as a computer readable tangible storage device or a computer readable physical storage device. In other words, computer readable storage media 724 is a media that can be touched by a person.

Alternatively, program code 718 may be transferred to data processing system 700 using computer readable signal media 726. Computer readable signal media 726 may be, for example, a propagated data signal containing program code 718. For example, computer readable signal media 726 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 718 may be downloaded over a network to persistent storage 708 from another device or data processing system through computer readable signal media 726 for use within data processing system 700. For instance, program code stored in a computer readable storage medium in a server data processing system may be downloaded over a network from the server to data processing system 700. The data processing system providing program code 718 may be a server computer, a client computer, or some other device capable of storing and transmitting program code 718.

The different components illustrated for data processing system 700 are not meant to provide architectural limitations to the manner in which different embodiments may be implemented. The different illustrative embodiments may be implemented in a data processing system including components in addition to and/or in place of those illustrated for data processing system 700. Other components shown in FIG. 7 can be varied from the illustrative examples shown. The different embodiments may be implemented using any hardware device or system capable of running program code. As one example, data processing system 700 may include organic components integrated with inorganic components and/or may be comprised entirely of organic components excluding a human being. For example, a storage device may be comprised of an organic semiconductor.

In another illustrative example, processor unit 704 may take the form of a hardware unit that has circuits that are manufactured or configured for a particular use. This type of hardware may perform operations without needing program code to be loaded into a memory from a storage device to be configured to perform the operations.

For example, when processor unit 704 takes the form of a hardware unit, processor unit 704 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code 718 may be omitted, because the processes for the different embodiments are implemented in a hardware unit.

In still another illustrative example, processor unit 704 may be implemented using a combination of processors found in computers and hardware units. Processor unit 704 may have a number of hardware units and a number of processors that are configured to run program code 718. With this depicted example, some of the processes may be implemented in the number of hardware units, while other processes may be implemented in the number of processors.

In another example, a bus system may be used to implement communications fabric 702 and may be comprised of one or more buses, such as a system bus or an input/output bus. Of course, the bus system may be implemented using any suitable type of architecture that provides for a transfer of data between different components or devices attached to the bus system.

Additionally, communications unit 710 may include a number of devices that transmit data, receive data, or both transmit and receive data. Communications unit 710 may be, for example, a modem or a network adapter, two network adapters, or some combination thereof. Further, a memory may be, for example, memory 706, or a cache, such as that found in an interface and memory controller hub that may be present in communications fabric 702.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the figures. For example, the functions of two blocks shown in succession may be executed substantially concurrently, or the functions of the blocks may sometimes be executed in the reverse order, depending upon the functionality involved.

The description of the different illustrative embodiments has been presented for purposes of illustration and description and is not intended to be exhaustive or to limit the embodiments in the form disclosed. Many modifications and variations will be apparent to those of ordinary skill in the art. Further, different illustrative embodiments may provide different benefits as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A method for managing health of a passenger on an aircraft, comprising:
monitoring a physiological condition of the passenger seated in a seat in a cabin in the aircraft using a passenger condition sensor to provide passenger condition information, the physiological condition comprising: an oxygen level, a hydration level, and a blood sugar level;
monitoring an environmental condition in the cabin using a cabin condition sensor to provide cabin condition information;
monitoring an aircraft condition using an aircraft condition sensor to provide aircraft condition information, the aircraft condition comprising: a phase of flight of the aircraft, a weather condition outside the aircraft, a time of day, whether the aircraft is behind or ahead of schedule, and whether the aircraft is experiencing an emergency condition;
processing the passenger condition information, the cabin condition information, and the aircraft condition information to provide passenger health information; and
displaying the passenger health information to the passenger.

2. The method of claim 1, wherein the passenger condition sensor is located in the seat.

3. The method of claim 1, wherein the physiological condition of the passenger further comprises: at least one of: a body temperature, a heart rate, a respiration rate, a body position, and a body movement.

4. The method of claim 1, wherein the cabin condition sensor is selected from one of a temperature sensor, an air quality sensor, a pressure sensor, a sound sensor, a vibration sensor, an acceleration sensor, a light sensor, and a humidity sensor.

5. The method of claim 1, wherein processing the passenger condition information, the aircraft condition information, and the cabin condition information comprises automatically diagnosing a health condition of the passenger and including an indication of the health condition in the passenger health information.

6. The method of claim 1 further comprising displaying the passenger health information to one of another passenger on the aircraft, a cabin crew, and a flight crew.

7. The method of claim 1 further comprising transmitting the passenger health information off board the aircraft.

8. The method of claim 1 further comprising using the passenger health information to automatically change the environmental condition in the cabin.

9. The method of claim 1 further comprising applying privacy controls to control privacy of the passenger condition information.

10. An apparatus, comprising:
a passenger condition sensor configured to monitor a physiological condition of a passenger seated in a seat in a cabin in an aircraft and provide passenger condition information, the physiological condition comprising: an oxygen level, a hydration level, and a blood sugar level;
a cabin condition sensor configured to monitor an environmental condition in the cabin and provide cabin condition information;
an aircraft condition sensor configured to monitor an aircraft condition and provide aircraft condition information, the aircraft condition comprising: a phase of flight of the aircraft, a weather condition outside the aircraft, a time of day, whether the aircraft is behind or ahead of schedule, and whether the aircraft is experiencing an emergency condition;
a controller configured to receive and process the passenger condition information and the cabin condition information to provide passenger health information; and
a passenger interface configured to display the passenger health information to the passenger.

11. The apparatus of claim 10, wherein the passenger condition sensor is located in the seat.

12. The apparatus of claim 10, the physiological condition of the passenger further comprising: a body temperature, a heart rate, a respiration rate, a body position, and a body movement.

13. The apparatus of claim 10, wherein the cabin condition sensor is selected from one of a temperature sensor, an air quality sensor, a pressure sensor, a sound sensor, a vibration sensor, an acceleration sensor, a light sensor, and a humidity sensor.

14. The apparatus of claim 10, wherein the controller is configured to process the passenger condition information, the aircraft condition information, and the cabin condition information, and automatically diagnose a health condition of the passenger and indicate the health condition in the passenger health information.

15. The apparatus of claim 10, wherein the passenger interface is configured to receive passenger health information and the controller is configured to receive the passenger health information and to process the passenger health information to provide the passenger health information.

16. The apparatus of claim 10, wherein the passenger interface is configured to provide a data interface for providing the passenger health information to an information storage device provided by the passenger.

17. A method for managing health of a passenger on an aircraft, comprising:
monitoring a physiological condition of the passenger in a cabin in the aircraft using a passenger condition sensor to provide passenger condition information;
monitoring an environmental condition in the cabin using a cabin condition sensor to provide cabin condition information;
monitoring an aircraft condition using an aircraft condition sensor to provide aircraft condition information, the aircraft condition comprising: a phase of flight of the aircraft, a weather condition outside the aircraft, a time of day, whether the aircraft is behind or ahead of schedule, and whether the aircraft is experiencing an emergency condition;
receiving passenger health information; and
processing the passenger condition information, the cabin condition information, the aircraft condition information and the passenger health information to provide passenger health information.

18. The method of claim 17 further comprising applying privacy controls to control privacy of the passenger condition information and the passenger provided health information.

19. The method of claim 18, wherein applying the privacy controls comprises aggregating the passenger condition information for a plurality of passengers.

20. The method of claim 17 further comprising using the passenger health information to automatically change the environmental condition in the cabin.
